(19) United States
(12) Patent Application Publication
(10) Pub. No.: US 2020/0167389 A1
(43) Pub. Date: May 28, 2020

(54) SEARCHING METHOD AND SEARCHING SYSTEM

(71) Applicants: Inventec (Pudong) Technology Corporation, Shanghai (CN); INVENTEC CORPORATION, TAIPEI CITY (TW)

(72) Inventors: Cheng-Hsin CHEN, TAIPEI CITY (TW); Chun-Hung LIN, TAIPEI CITY (TW); Yan-Yue YIN, TAIPEI CITY (TW)

(21) Appl. No.: 16/421,449

(22) Filed: May 23, 2019

(30) Foreign Application Priority Data
Nov. 26, 2018 (CN) 201811417033.0

(51) Int. Cl. G06F 16/9032; G06F 16/901; G06F 16/903; G06F 16/9038

(52) U.S. Cl. CPC G06F 16/90328; G06F 16/9038; G06F 16/90344; G06F 16/9024

(57) ABSTRACT

A searching method includes the following steps: receiving a search keyword, generating a plurality of first graphical nodes, according to the search keyword, recommending a plurality of second graphical nodes, according to the search keyword at least selected one of the plurality of first graphical nodes, and recommending a target graphical node, according to the search keyword at least the selected one of the plurality of first graphical nodes and at least selected one of the plurality of second graphical nodes.

### CROSS-REFERENCE TO RELATED APPLICATION

This application claims priority to China Application Serial Number 201811417033.0, filed Nov. 26, 2018, which is herein incorporated by reference in its entirety.

### BACKGROUND

### Technical Field

The present disclosure relates to a searching system and method. More particularly, the present disclosure relates to a searching system and method based on data correlation.

### Description of Related Art

The traditional system for searching data and data display mode are mostly displayed by using the list. The user needs to check or filter the content one by one to find the required data. It is not easy for the user to determine which search result satisfies his required file data in the traditional list presentation, mainly because the list fails to present the correlation between the search results.

Humans process images faster than text. Therefore, presenting the data display mode in a graphical manner allows users to search for the required data more intuitively. Stimulating vision through interaction can help users understand the relationship of each topic in the professional field involved in the searched file data more quickly and clearly.

### SUMMARY

In one embodiment of the present disclosure, a searching method includes the following steps: receiving a search keyword, generating a plurality of first graphical nodes, according to the search keyword, recommending a plurality of second graphical nodes, according to the search keyword at least selected one of the plurality of first graphical nodes, and recommending a target graphical node, according to the search keyword at least the selected one of the plurality of first graphical nodes and at least selected one of the plurality of second graphical nodes.

In another embodiment of the present disclosure, a searching system includes a processor and a storage device. The processor is configured to receive a search keyword, and generate a plurality of first graphical nodes, according to the search keyword and a selection record. The processor is further configured to recommend, according to selecting at least one of the first graphical nodes, a plurality of second graphical nodes. The processor is further configured to recommend, according to the selected at least one of the second graphical nodes, a target graphical node. The storage device is coupled to the processor, and configured to store at least the selected one of the first graphical nodes, at least the selected one of the second graphical nodes, and the recommended target graphical node as the selection record. Moreover, the plurality of first graphical nodes, the plurality of second graphical nodes, and the target graphical node are selectively connected therebetween, according to the search keyword a correlation strength of a correlation operation.

To sum up above, the searching system and the searching method use the graphical nodes to improve the inconvenience caused by the traditional searching interface, generate a plurality of graphical nodes, according to the search keyword input by the user, then calculate the correlation, according to the search keyword the graphical node selected by the user, find the target graphical node that the user requires, and present the correlation strengths between the different target graphical nodes in different display modes, so that the user can quickly search and find the required file data.

### BRIEF DESCRIPTION OF THE DRAWINGS

FIG. 1 illustrates a functional block diagram of a searching system according to one embodiment of the present disclosure.

FIG. 2 illustrates a schematic diagram of generating graphical nodes according to one embodiment of the present disclosure.

FIG. 3 illustrates a schematic diagram of correlation strengths of the graphical nodes according to another embodiment of the present disclosure.

FIG. 4 illustrates a flowchart of a searching method according to one embodiment of the present disclosure.

FIG. 5 illustrates a detailed flowchart of further steps included in step S410 in the searching method of FIG. 4 in some embodiments.

FIG. 6 illustrates a detailed flowchart of further steps included in step S420 in the searching method of FIG. 4 in some embodiments.

FIG. 7 illustrates a detailed flowchart of further steps included in step S430 in the searching method of FIG. 4 in some embodiments.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

The terms “comprise”, “include”, “have” and “contain” as used herein are all open terms, that is, mean “including, but not limited to”. Also, the term “and/or” as used herein includes any or all combinations of one or more items in related listed items.

As used herein, when an element is referred to as “connected” or “coupled”, it may mean “electrically connected” or “electrically coupled”. The term “connected” or “coupled” may mean that two or more elements co-operate or interact with each other. Further, although the terms “first”, “second” and the like as used herein describe different elements, the terms are only used for distinguishing elements or operations described with like technical terms. Unless clearly indicated in the context, the terms neither necessarily refer to or imply an order or sequence nor are intended to limit the present disclosure.

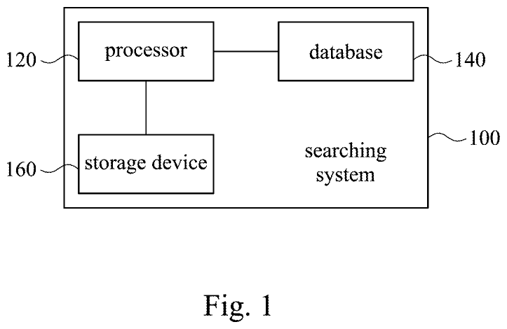

Reference is made to FIG. 1. FIG. 1 illustrates a functional block diagram of a searching system 100 according to one embodiment of the present disclosure. The searching system 100 includes a processor 120, a database 140, and a storage device 160. The processor 120 is communicatively coupled to the database 140 and the storage device 160. In one embodiment, the searching system 100 may be a file searching system, the processor 120 may be a central processing unit, a microprocessor or other components having a data processing function, the database 140 may be a file database for storing files, and the storage device 160 may be a hard disk, a disk array, a tape drive, a non-volatile memory, or other electronic storage media.

It should be noted that the implementation of the devices and components in the aforementioned searching system 100 is not limited to the aforementioned embodiments, and the connection relationship is not limited to the aforementioned embodiments as well. Any connection and implementation sufficient for the searching system 100 to implement the technical content below can be applied to the present disclosure.

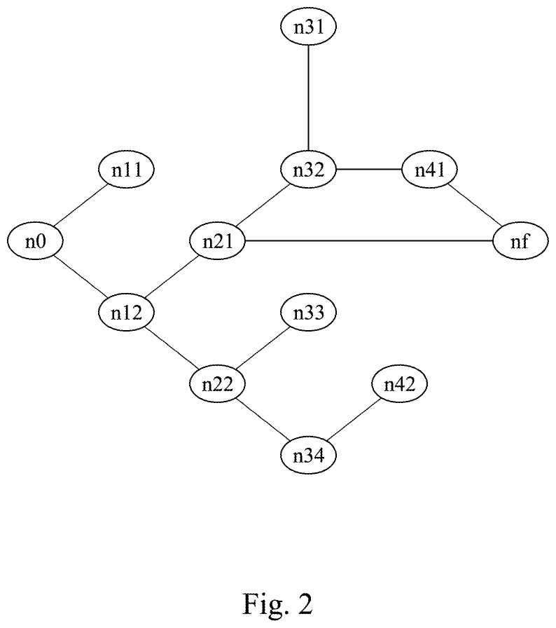

Reference is made to FIG. 2. FIG. 2 illustrates a schematic diagram of a knowledge correlation diagram for generating graphical nodes, according to the search keyword one embodiment of the present disclosure. In one embodiment, the processor 120 in the searching system 100 receives a search keyword, and generates a plurality of first graphical nodes, according to the search keyword and a selection record. The processor 120 recommends, according to at least one of the plurality of first graphical nodes selected by the user, a plurality of second graphical nodes. The processor 120 further recommends a target graphical node, according to the search keyword at least selected one of the plurality of second graphical nodes.

For example, the user wants to consult file data about the transistor, the user can input “transistor” as a search keyword in the searching system 100. After the processor 120 in the searching system 100 receives the search keyword, based on the search keyword and the selection record, a plurality of graphical nodes as shown in FIG. 2 are generated. For example, the graphical node n12 is “field effect transistor”, the graphical node n21 is “N-type”, and the graphical node nf is “N-type metal oxide semiconductor field effect transistor (MOSFET)”. When the user selects the graphical node n12, the processor 120 determines that “field effect transistor” is related to “N-type” and thus recommends the graphical node n21 to the user. When the user selects the graphical node n21, the processor 120 determines that the user may eventually want to search for the data of the N-type metal oxide semiconductor field effect transistor. The processor 120 sets the graphical node nf as the target graphical node and recommends the graphical node nf to the user.

In one embodiment, the storage device 160 in the searching system 100 is coupled to the processor 120, and the storage device 160 stores at least the selected one of the plurality of first graphical nodes, at least the selected one of the plurality of second graphical nodes and the target graphical node as the selection record.

The storage device 160 stores the result of the aforementioned user operation as the selection record. When the graphical nodes are generated next time, more accurate graphical nodes are generated, according to the search keyword the corresponding user selection record. When the amount of the selection records in the storage device 160 is sufficient (e.g., thousands or more), the selection records can be used as reference data for machine learning to establish a neural network model. In the future, when the user initially operate the image data of the correlation graph, the image data can be identified and classified by the neural network model to predict the user's target graphical node, the final target graphical node which may be selected is highlighted or displayed with different colors or the relevant data of the target graphical node may be directly opened.

In one embodiment, each of the first graphical nodes includes a first node keyword, and the first node keyword is generated by the processor 120 performing a correlation operation on the search keyword. Each of the second graphical nodes includes a second node keyword, and the second node keyword is generated by the processor 120 performing the correlation operation on the first node keyword. The target graphical node includes a target node keyword, and the target node keyword is generated by the processor 120 performing the correlation operation on the first node keyword and the second node keyword.

In one embodiment, the searching system 100 further includes a database 140. The database 140 is coupled to the processor 120 and is configured to store the file data. The correlation operation includes the processor 120 using the search keyword, the first node keyword or the second node keyword to search the content of the file data, and selecting the file data including the search keyword, the first node keyword or the second node keyword.

In one embodiment, the correlation operation includes the processor 120 calculating a first occurrence number of the first keyword for the selected file data. When the first occurrence number is greater than a reference occurrence number, the processor 120 is configured to set the first keyword as the first node keyword. The second occurrence number of the second keyword is calculated for the selected file data. When the second occurrence number is greater than the reference occurrence number, the processor 120 is configured to set the second keyword as the second node keyword. The third occurrence number of the third keyword is calculated for the selected file data. When the third occurrence number is greater than the reference occurrence number, the processor 120 is configured to set the third keyword as the target node keyword.

For example, the processor 120 may set the reference occurrence number as 100 times, and the searched first keyword must appear more than 100 times to be as the candidate for the first node keyword. For example, if the search keyword is “gate driver”, the searching system 100 first selects the files which describe the gate driver. In the files describing the gate driver, the first keyword that often appears may be “transistor” or “shift register”, and “transistor” or “shift register” may be set as the first keyword and be searched again to determine whether the number of occurrence is greater than 100 times, the reference occurrence number. For example, if the number of occurrence of “transistor” is greater than 100 times, “transistor” is set as the first node keyword, and the graphical node corresponding to the transistor is recommended to the user.

In another embodiment, each graphical node may further generate, in addition to the first node keyword, the second node keyword, or the target node keyword, a set of special keywords. The special keywords have the characteristic of unique identification, and may be strings other than the first node keyword, the second node keyword or the target node keyword, or special codes or cryptograms which are preset by the searching system 100 in the corresponding data file. The first node keyword, the second node keyword, the target node keyword, and the special keyword are all available for the processor 120 as the basis to search the database 160. The result of searching with the special keyword is more unique, indicating that the file data the user requires are more confirmed so that the search results are more accurate.

In one embodiment, the correlation operation includes, when the first occurrence number, the second occurrence number, or the third occurrence number is greater than a high standard occurrence number, the processor 120 excluding the first keyword, the second keyword, or the third keyword. In other words, the current first keyword, the second keyword or the third keyword may be a common vocabulary without knowledge value, and thus is excluded.

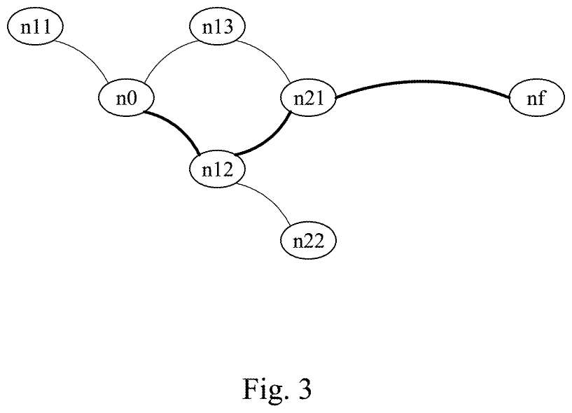

The connection between the graphical nodes can also be presented by the correlation strengths between the keywords. Reference is made to FIG. 3. FIG. 3 illustrates a schematic diagram of the correlation strengths of the graphical nodes according to another embodiment of the present disclosure. In another embodiment, for example, when the keyword input by the user is “display panel”, the graphical node n0 is “display panel”, and the graphical node n12 may be “light sensing component”. The correlation strength between the light sensing component and the display panel is greater, thus, the connection between the graphical node n0 and the graphical node n12 is widened such that the user realize more intuitively that the correlation between the graphical node n0 and the graphical node n12 is stronger. Otherwise, in other embodiments, the color of the connection between the graphical node n0 and the graphical node n12 may also be changed, for example, changing the color to red (not shown in the figure), in order the user realize more intuitively that the correlation between those two is stronger. The graphical node n21 can be “gate driver”, the searching system 100 can predict that the user wants to find the data about the thin film transistor (TFT), and set the graphical node of corresponding to the thin film transistor as the target graphical node.

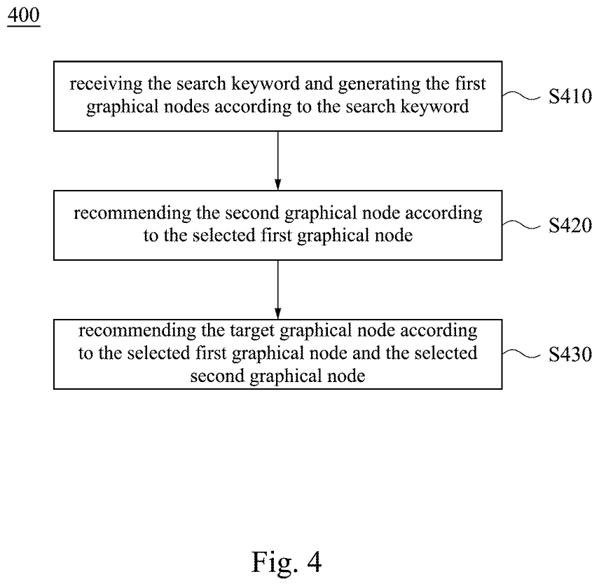

Reference is made to FIG. 4. FIG. 4 illustrates a flowchart of a searching method 400 according to one embodiment of the present disclosure. For ease of understanding the searching method 400, reference is made to FIG. 1 in conjunction with FIG. 4. In the searching method 400, in step S410, the processor 120 in the searching system 100 receives the search keyword input by the user. In step S420, the processor 120 recommends the second graphical node, according to the search keyword the selected first graphical node. In step S430, the processor 120 recommends the target graphical node, according to the search keyword the selected first graphical node and the selected second graphical node.

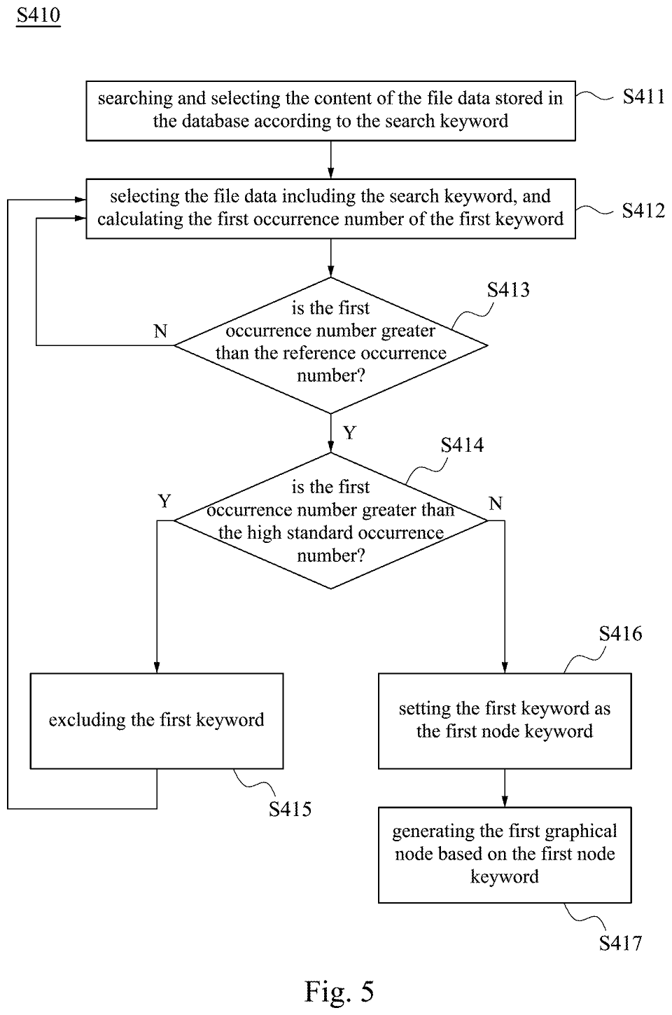

Reference is made to FIG. 5. FIG. 5 illustrates a detailed flowchart of further steps included in step S410 in the searching method 400 of FIG. 4 in some embodiments. In step S411, the processor 120 searches and selects the content of the file data stored in the database 160, according to the search keyword. In step S412, the processor 120 selects the file data including the search keyword, and calculates the first occurrence number of the first keyword. In step S413, the processor 120 determines whether the first occurrence number is greater than the reference occurrence number. If it is, then step S414 is performed and the processor 120 determines whether the first occurrence number is greater than the set high standard occurrence number. If it is not, then step S412 is performed to continue selecting other first keywords. Reference is made to step S414, when the first occurrence number of the first keyword is greater than the high standard occurrence number, the processor 120 determines that the current first keyword may be a common vocabulary without knowledge value, and step S415 is performed to exclude the current first keyword and then, back to step S412, step S412 is performed to continue selecting other first keywords. When the first occurrence number of the first keyword is less than the high standard occurrence, step S416 is performed to set the current first keyword as the first node keyword, and in step S417 the first graphical node is generated based on the first node keyword.

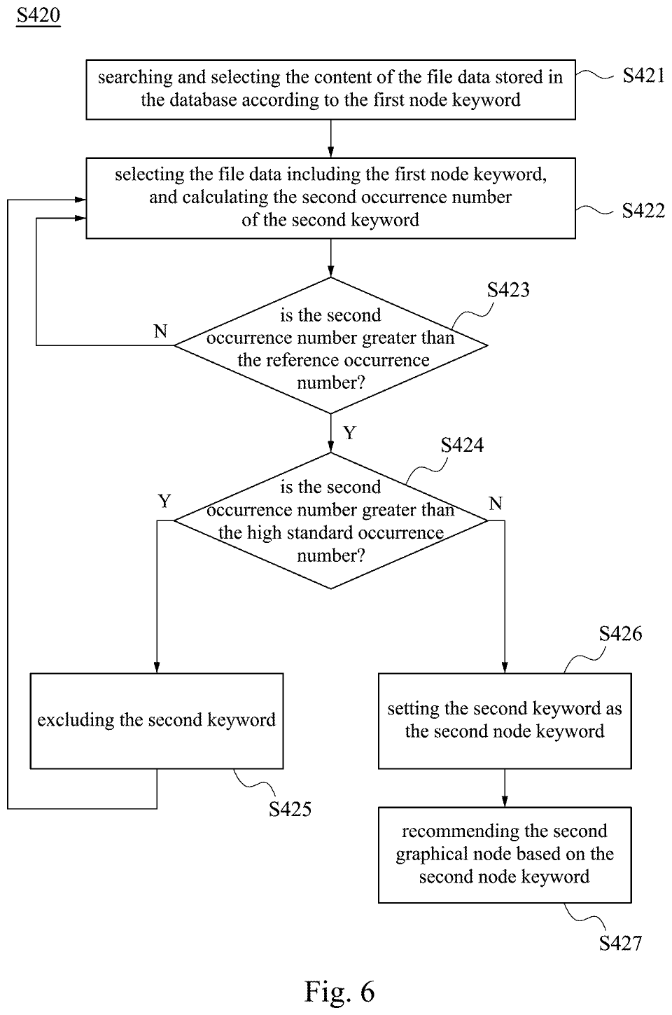

Reference to FIG. 6. FIG. 6 illustrates a detailed flowchart of further steps included in step S420 in the searching method 400 of FIG. 4 in some embodiments. In step S421, the processor 120 searches and selects, according to the first node keyword generated in the aforementioned steps, the content of the file data stored in the database 160. In step S422, the processor 120 selects the file data including the first node keyword, and calculates the second occurrence number of the second keyword which is different from the first node keyword. In step S423, the processor 120 determines whether the second occurrence number is greater than the reference occurrence number. If it is, step S424 is performed and the processor 120 determines whether the second occurrence number is greater than the set high standard occurrence number. If it is not, then, back to step S422, step S422 is performed to continue selecting other second keywords. When the second occurrence number of the second keyword is greater than the high standard occurrence number, the processor 120 determines that the current second keyword may be a common vocabulary without knowledge value, and step S425 is performed to exclude the current second keyword and then, back to step S422, step S422 is performed to continue selecting other second keywords. When the second occurrence number of the second keyword is less than the high standard occurrence number, step S426 is performed to set the current second keyword as the second node keyword and in step S427 the second graphical node corresponding to the second keyword is recommended to the user.

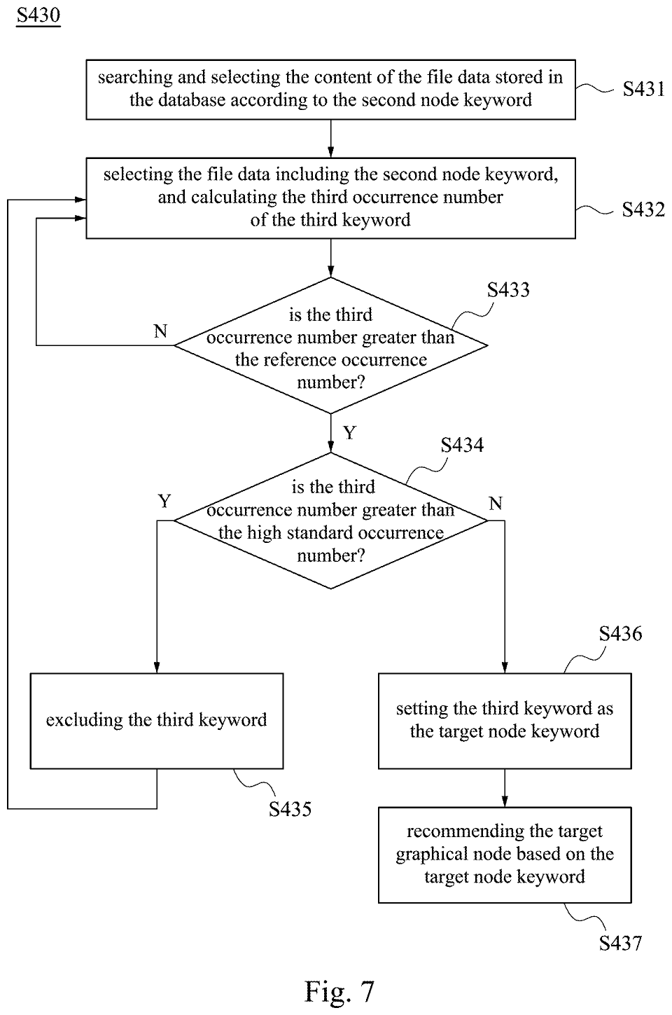

Reference is made to FIG. 7. FIG. 7 illustrates a detailed flowchart of further steps included in step S430 in the searching method 400 of FIG. 4 in some embodiments. In step S431, the processor 120 searches and selects, according to the second node keyword generated in the aforementioned steps, the content of the file data stored in the database 160. In step S432, the processor 120 selects the file data including the second node keyword, and calculates the third occurrence number of the third keyword which is different from the first node keyword and the second node keyword. In step S433, the processor 120 determines whether the third occurrence number is greater than the reference occurrence number. If it is, step S434 is performed and the processor 120 determines whether the third occurrence number is greater than the set high standard occurrence number. If it is not, then, back to S432, step S432 is performed to continue selecting other third keywords. When the third occurrence number of the third keyword is greater than the high standard occurrence number, the processor 120 determines that the current third keyword may be a common vocabulary with no knowledge value, and step S435 is performed to exclude the current third keyword and then, back to S432, step S432 is performed to continue selecting other third keywords. When the third occurrence number of the third keyword is less than the high standard occurrence number, step S436 is performed to set the current third keyword as the third node keyword, and in step S437, the target graphic node corresponding to the third node keyword is recommended to the user.

To sum up above, the searching system and the searching method use the graphical nodes to improve the inconvenience caused by the traditional searching interface, generate a plurality of graphical nodes, according to the search keyword input by the user, then calculate the correlation, according to the search keyword the graphical node selected by the user, find the target graphical node that the user requires, and present the correlation strengths between the different target graphical nodes in different display modes, so that the user can quickly search and find the required file data.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the invention. In view of the foregoing, it is intended that the present disclosure cover modifications and variations of this invention provided they fall within the scope of the following claims.

What is claimed is:

1. A searching method, comprising:
receiving a search keyword, and generating a plurality of first graphical nodes, according to the search keyword;
recommending a plurality of second graphical nodes, according to at least selected one of the plurality of first graphical nodes; and
recommending a target graphical node, according to at least the selected one of the plurality of first graphical nodes and at least selected one of the plurality of second graphical nodes.

2. The searching method of claim 1, wherein each of the plurality of first graphical nodes comprises a first node keyword, each of the plurality of second graphical nodes comprises a second node keyword, and the target graphical node comprises a target node keyword, wherein the searching method further comprises:
performing a correlation operation on the search keyword to generate the first node keyword;
performing the correlation operation on the first node keyword to generate the second node keyword; and
performing the correlation operation on the first node keyword and the second node keyword to generate the target node keyword.

3. The searching method of claim 2, wherein the correlation operation comprises:
searching content of file data stored in a database, according to the search keyword, the first node keyword, or the second node keyword; and
selecting the file data comprising the search keyword, the first node keyword or the second node keyword.

4. The searching method of claim 3, wherein the correlation operation further comprises:
calculating a first occurrence number of a first keyword for the selected file data, wherein when the first occurrence number is greater than a reference occurrence number, the first keyword is set as the first node keyword;
calculating a second occurrence number of a second keyword for the selected file data, wherein when the second occurrence number is greater than the reference occurrence number, the second keyword is set as the second node keyword; and
calculating a third occurrence number of a third keyword for the selected file data, wherein when the third occurrence number is greater than the reference occurrence number, the third keyword is set as the target node keyword.

5. The searching method of claim 4, wherein the correlation operation further comprises:
when the first occurrence number, the second occurrence number, or the third occurrence number is greater than a high standard occurrence number, excluding the first keyword, the second keyword, or the third keyword.

6. A searching system, comprising:
a processor configured to receive a search keyword and generate a plurality of first graphical nodes, according to the search keyword and a selection record,
wherein the processor is further configured to recommend, according to at least selected one of the plurality of first graphical nodes, a plurality of second graphical nodes,
wherein the processor is further configured to recommend, according to at least selected one of the plurality of second graphical nodes, a target graphical node; and
a storage device coupled to the processor and configured to store at least the selected one of the plurality of first graphical nodes, at least the selected one of the plurality of second graphical nodes, and the target graphical node as the selection record,
wherein the plurality of first graphical nodes, the plurality of second graphical nodes, and the target graphical node are selectively connected therebetween, according to the search keyword a correlation strength of a correlation operation.

7. The searching system of claim 6, wherein each of the plurality of first graphical nodes comprises a first node keyword, and the first node keyword is generated by the processor performing the correlation operation on the search keyword;
each of the plurality of second graphical nodes comprises a second node keyword, and the second node keyword is generated by the processor performing the correlation operation on the first node keyword; and
the target graphical node comprises a target node keyword, and the target node keyword is generated by the processor performing the correlation operation on the first node keyword and the second node keyword.

8. The searching system of claim 7, further comprising:
a database coupled to the processor and configured to store file data,
wherein the correlation operation comprises operations: an operation of processor using the search keyword, the first node keyword or the second node keyword to search content of the file data, and an operation of the processor selecting the file data comprising the search keyword, the first node keyword or the second node keyword.

9. The searching system of claim 8, wherein the correlation operation comprises:
the processor calculating a first occurrence number of a first keyword for the selected file data, wherein when the first occurrence number is greater than a reference occurrence number, the processor is configured to set the first keyword as the first node keyword;
calculating a second occurrence number of a second keyword for the selected file data, wherein when the second occurrence number is greater than the reference occurrence number, the processor is configured to set the second keyword as the second node keyword; and
calculating a third occurrence number of a third keyword for the selected file data, wherein when the third occurrence number is greater than the reference occurrence number, the processor is configured to set the third keyword as the target node keyword.

10. The searching system of claim 9, wherein the correlation operation comprises, when the first occurrence number, the second occurrence number or the third occurrence number is greater than a high standard occurrence number, the processor excluding the first keyword, the second keyword, or the third keyword.
